(19) United States
(12) Patent Application Publication
(10) Pub. No.: US 2013/0106012 A1
(43) Pub. Date: May 2, 2013

(54) Manufacture process for high wear-heat resistant parts carbon brushes & brake pads ASTM preform slurry electrolyte carbon nanofoam CNFs & 2.5 phase design and precision die cast extrusion for highly pure metal, super alloy, ceramics, alkaline, and alkalide

(71) Applicant: Robert Richard Matthews, Washington, DC (US)

(72) Inventor: Robert Richard Matthews, Washington, DC (US)

(21) Appl. No.: 13/459,173

(22) Filed: Apr. 28, 2012

Related U.S. Application Data
(63) Continuation-in-part of application No. 13/284,935, filed on Nov. 2, 2011.

(51) Int. Cl. B29C 47/00; B82Y 40/00

(52) U.S. Cl. 264/42; 977/888

(57) ABSTRACT

The variable hydraulic preform slurry electrolyte carbon extrusion high wear-heat resistant parts press is utilized to manufacture process specified scientific formula preform slurry electrolyte extrusion carbon nanofoam CNFs, with or without ionic suspension element to manufacture 1. preform slurry electrolyte carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, electronic resistors, transformers, transducers, rectifiers, power supplies, or heat sinks, 2. Preform slurry electrolyte carbon nanofoam CNFs extrusion high wear-heat resistant parts aerospace, automotive, and transportation brake calipers, rotors, bushings, and pads, and 3. Preform slurry electrolyte carbon nanofoam CNFs extrusion high wear-heat resistant parts precision casting molds for the manufacturing of highly pure metal, super alloy, alkaline, alkalide, or ceramics specializing in 2.5 phase die cast mold extrusions.

### DOMESTIC PRIORITY DATA

This is an application a continuation in part of preliminary amendment to specification application-Ser. No. 13/284,935 filing date Nov. 2, 2011.

### BACKGROUND OF THE INVENTION

Global warming and growing concerns of Greenhouse gas emissions from our dependency on fossil fuels are creating real demand and awareness for an electric alternative and improvements to existing technology is fast on the move. Few technological developments of collecting and manufacturing carbon nanofoam CNFs improve upon our existing technological structure. By applying general science utilization of preform technology the variable hydraulic preform slurry electrolyte carbon nanofoam CNFs extrusion high wear-heat resistant parts press with manufactured or processed carbon nanofoam CNFs assembled resources, we can now create the manufacture process of preform slurry electrolyte carbon nanofoam CNFs extrusion high wear-heat resistant parts.

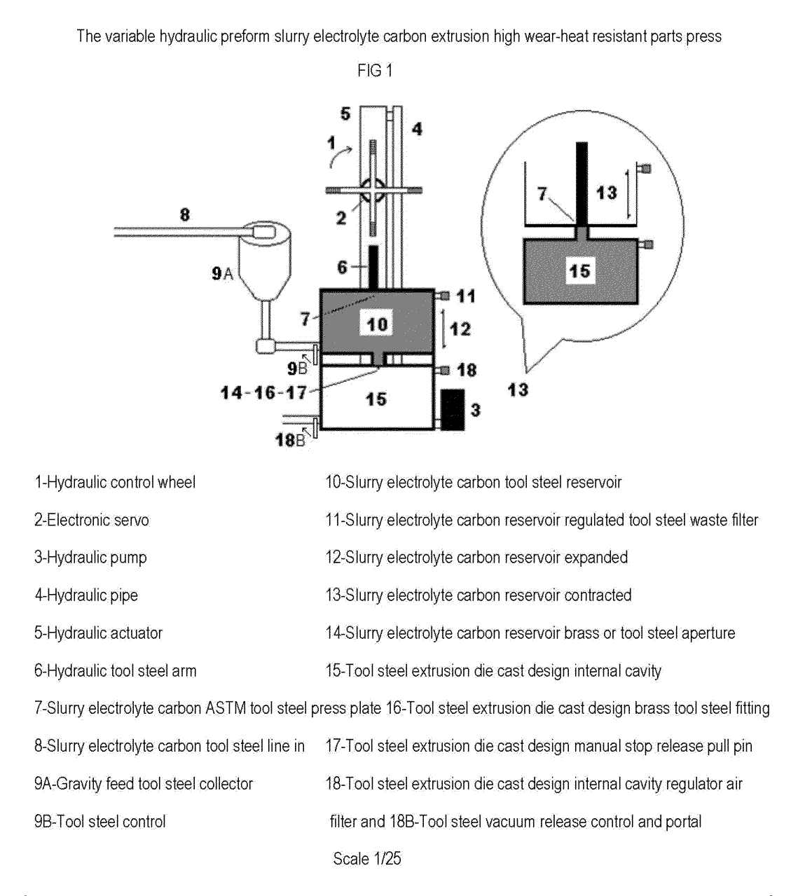

### BRIEF DESCRIPTION OF FIG. 1

FIG. 1 the variable hydraulic preform slurry electrolyte carbon nanofoam CNFs extrusion high wear-heat resistant parts press.

### DETAILED DESCRIPTION OF FIG. 1

Variable hydraulic preform slurry electrolyte carbon extrusion high wear-heat resistant parts press, 1—Hydraulic control wheel 2—Electronic servo 3—Hydraulic pump 4—Hydraulic pipe 5—Hydraulic actuator 6—Hydraulic tool steel arm 7—Slurry electrolyte carbon ASTM tool steel press plate 8—Slurry electrolyte carbon tool steel line in 9A—Gravity feed tool steel collector 9B—Tool steel release control portal 10—Slurry electrolyte carbon tool steel reservoir 11—Slurry electrolyte carbon reservoir regulated tool steel waste filter 12—Slurry electrolyte carbon tool steel reservoir expanded 13—Slurry electrolyte carbon tool steel reservoir contracted 14—Slurry electrolyte carbon reservoir brass-tool steel aperture 15—Tool steel extrusion die cast design brass-tool steel fitting 16—Tool steel electronic servo or manual stop control release pull pin 17—Tool steel extrusion die cast design internal cavity 18—Tool steel extrusion die cast design internal cavity regulator waste filter and 18B—Tool steel vacuum release control portal.

### BRIEF SUMMARY OF THE INVENTION

General science utilization of preform technology the variable hydraulic preform slurry electrolyte carbon nanofoam CNFs extrusion high wear-heat resistant parts press FIG. 1 with manufactured or processed carbon nanofoam CNFs available resources enables the manufacture process of high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, bushings, and pads, and precision casting molds for the manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator specifically up to 2.5 phase extrusions for each A and B specification part.

### DETAILED DESCRIPTION OF THE INVENTION

The variable hydraulic preform slurry electrolyte extrusion allotropes of carbon atomic number 6 symbol C herein referred to as slurry electrolyte carbon or carbon nanofoam CNFs and high wear-heat resistant parts press, the center of this utility patent application specification manufacture process of specified scientific formula preform slurry electrolyte extrusion carbon nanofoam CNFs solids, liquids, and/or gases, heated, chilled, or room temperature chemical electrolyte ionic melts, ionic fluids, and/or fused, and/or catalyst acid and bases, actual catalyst, and/or catalyst reservoir with or without ionic suspension element specification 40 element, and/or specification 41 alloy to manufacture 1. preform slurry electrolyte carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts, 2. Preform slurry electrolyte carbon nanofoam CNFs extrusion high wear-heat resistant parts aerospace, automotive, and transportation brake calipers, rotors, bushings, and pads, 3. Preform slurry electrolyte carbon nanofoam CNFs extrusion high wear-heat resistant parts precision casting molds for the manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator up to 2.5 phase extrusions for each A and B specification part.

The variable hydraulic preform slurry electrolyte carbon extrusion high wear-heat resistant parts press FIG. 1 numbers 1 to 18 specific components conform to specified requirements to unique American Society for Testing and Materials ASTM International Standards Worldwide Identifiers.

The 1—Hydraulic control wheel is connected to the 2—Electronic servo and allows the operator to expand and contract 7—Slurry electrolyte carbon ASTM tool steel press plate primarily to expand the 10—Slurry electrolyte carbon tool steel reservoir by moving the 1—Hydraulic control wheel in a fully counter clockwise fashion. This allows the operator to initiate a separate machine to pump slurry electrolyte carbon into the 8—Slurry electrolyte carbon tool steel line in, subsequently to the 9—Gravity feed collector line out and finally to the 10—Slurry electrolyte carbon tool steel reservoir. Slurry electrolyte carbon is defined here as specified scientific formula preform slurry electrolyte extrusion carbon nanofoam CNFs solids, liquids, and/or gases, heated, chilled, or room temperature chemical electrolyte ionic melts, ionic fluids, and/or fused, and/or catalyst acid and bases, actual catalyst, and/or catalyst reservoir with or without ionic suspension element specification 40 element, and/or specification 41 alloy to manufacture preform slurry electrolyte carbon nanofoam CNFs extrusion high wear-heat resistant parts. After the 10—Slurry electrolyte carbon tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry electrolyte carbon ASTM tool steel press plate and forcing the slurry electrolyte carbon comprised of carbon nanofoam CNFs and slurry electrolyte formula into the 17—Tool steel extrusion die cast design internal cavity. The specified amount of slurry electrolyte carbon is compressed to preform slurry electrolyte carbon nanofoam CNFs extrusion specification pressure measured in millibars Mb until the specified slurry electrolyte carbon required to fill the 17—Tool steel extrusion die cast design internal cavity has been reached. The 1—Hydraulic control wheel is then locked until the 17—Tool steel extrusion die cast design internal cavity has been removed.

The 2—Electronic servo sends an electrical signal to the 3—Hydraulic pump of the 7—Slurry electrolyte carbon ASTM tool steel press plate position that is calibrated to the 1—Hydraulic control wheel.

The 3—Hydraulic pump receives an electrical signal from the 2—Electronic servo of the 7—Slurry electrolyte carbon ASTM tool steel press plate position that is calibrated to the 1—Hydraulic control wheel. The 3—Hydraulic pump pumps fluids to the 4—Hydraulic pipe.

The 4—Hydraulic pipe receives fluids from the 3—Hydraulic pump and conveys the fluids to the 5—Hydraulic actuator.

The 5—Hydraulic actuator receives fluids from the 4—Hydraulic pipe and the force from the fluids is transferred through the actuator as vertical up-and-down movement to an affixed 6—Hydraulic arm.

The 6—Hydraulic arm moves vertically up-and-down and forces the 7—Slurry electrolyte carbon ASTM tool steel press plate to expand and contract.

The 7—Slurry electrolyte carbon ASTM tool steel press plate is forced by the 6—Hydraulic arm to expand and contract.

The 8—Slurry electrolyte carbon tool steel line in receives slurry electrolyte carbon from an external pump and conveys them to the 9A—Gravity feed tool steel collector. The 8—Slurry electrolyte carbon tool steel line in can be ionic process tool steel interface positive or negative electrode electronically charged slurry electrolyte carbon particles for enhanced formulation.

The 9A-Gravity feed tool steel collector receives slurry electrolyte carbon from the 8—Slurry electrolyte carbon tool steel line in and conveys them to the 10—Slurry electrolyte carbon tool steel reservoir.

The 10—Slurry electrolyte carbon tool steel reservoir receives slurry electrolyte carbon from the 9A—Gravity feed tool steel collector line out.

After the 10—Slurry electrolyte carbon tool steel reservoir is filled the 9B—Tool steel control is utilized to close the opening to prepare for the extrusion and may be provisionally locked and stopped at any position.

The 11—Slurry electrolyte carbon reservoir regulated tool steel waste filter removes waste from the 10—Slurry electrolyte carbon tool steel reservoir while it is being filled with slurry electrolyte carbon from common recovery distillation heated interface tool steel and thermometer gauge, ordinary atmospheric pressure, vacuum pump barometric pressure measured in millibars Mb, and fractional distillation.

The 12—Slurry electrolyte carbon reservoir expanded.

The 13—Slurry electrolyte carbon reservoir contracted.

The 14—Slurry electrolyte carbon reservoir brass or tool steel aperture and 15—Tool steel extrusion die cast design brass or tool steel fitting connects directly and conveys slurry electrolyte carbon to the 17—Tool steel extrusion die cast design internal cavity. Again the 18—Tool steel extrusion die cast design internal cavity regulator waste filter and 18B—Tool steel vacuum release control and portal works in unison with the ASTM press plate drawing expanding and contracting slurry electrolyte carbon removing waste from the 17—Tool steel extrusion die cast design internal cavity while it is being filled with slurry electrolyte carbon from common recovery distillation heated interface tool steel and thermometer gauge, ordinary atmospheric pressure, vacuum pump barometric pressure measured in millibars Mb, and fractional distillation.

The 17—Tool steel extrusion die cast internal cavity is designed as a tool steel extrusion die cast mold for each carbon nanofoam CNFs part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 23 to supplement the development of extrusion die cast master design manufacture process with high purity tool steel die cast extrusion molds.

Carbon nanofoam CNFs brake pads and electronic brushes require two master extrusion tool steel mold halves for each specification part. Carbon nanofoam CNFs parts precision casting molds requires a minimum two and a maximum of six master extrusion tool steel mold halves for each specification part.

Carbon nanofoam CNFs parts precision casting molds are utilized to manufacture highly pure metal, super alloy, alkaline, alkalide, nonconductive zirconia, carbon nanofoam CNFs, alternate carbon nanofoam CNFs inductor, or impedance matching load or signal ceramic red brick clay insulator specifically up to 2.5 phase extrusions and six master carbon nanofoam CNFs mold halves per specification part.

The manufacture process of 2.5 phase extrusions and die cast design for highly pure metal, super alloy, alkaline, alkalide, nonconductive zirconia, carbon nanofoam CNFs, alternate carbon nanofoam CNFs inductor, or impedance matching load or signal ceramic red brick clay insulator requires six master extrusion tool steel halves for each six reciprocal carbon nanofoam CNFs master precision casting molds parts allowing two A and B highly pure metal, super alloy, alkaline, alkalide, nonconductive zirconia, carbon nanofoam CNFs, alternate carbon nanofoam CNFs inductor, or impedance matching load or signal ceramic red brick clay insulator to be combined. The 0.5 phase extrusion equals two die cast mold halves both equal to or less than one half 0.5 phase extrusion molten pour.

The specified highly pure metal, super alloy, alkaline, alkalide, nonconductive zirconia, carbon nanofoam CNFs, alternate carbon nanofoam CNFs inductor, or impedance matching load or signal ceramic red brick clay insulator part molten fill A and B fills up to four pours. The carbon nanofoam CNFs half-shell or 0.5 phase extrusion are designed and utilized for state of the art manufacture process when combining highly pure metal, super alloy, alkaline, alkalide, nonconductive zirconia, carbon nanofoam CNFs, alternate carbon nanofoam CNFs inductor, or impedance matching load or signal ceramic red brick clay insulator in combination of layered foundry fills.

The highly pure metal, super alloy, alkaline, alkalide, nonconductive zirconia, carbon nanofoam CNFs, alternate carbon nanofoam CNFs inductor, or impedance matching load or signal ceramic red brick clay insulator is a layered greater than 0% to less than 100% alloy component A and greater than 0% to less than 100% alloy component B part that is created in combination of layered foundry fills by utilizing up to six master carbon nanofoam CNFs parts precision casting molds per specification part by pouring molten fill as a layered alloying component highly pure metal, super alloy, alkaline, alkalide, nonconductive zirconia, carbon nanofoam CNFs, alternate carbon nanofoam CNFs inductor, or impedance matching load or signal ceramic red brick clay insulator up to four molten metal or other fill pours equal to 2.5 phase extrusions.

The highly pure metal, super alloy, alkaline, alkalide, nonconductive zirconia, carbon nanofoam CNFs, alternate carbon nanofoam CNFs inductor, or impedance matching load or signal ceramic red brick clay insulator is a layered greater than 0% to less than 100% highly pure metal, super alloy, alkaline, alkalide, nonconductive zirconia, carbon nanofoam CNFs, alternate carbon nanofoam CNFs inductor, or impedance matching load or signal ceramic red brick clay insulator A component part, and greater than 0% to less than 100% highly pure metal, super alloy, alkaline, alkalide, nonconductive zirconia, carbon nanofoam CNFs, alternate carbon nanofoam CNFs inductor, or impedance matching load or signal ceramic red brick clay insulator B component part created in combination of layered fills of six master carbon nanofoam CNFs extrusion die cast mold halves equal to 2.5 phase extrusions.

Super carbon alloy is defined as carbon nanofoam CNFs sintered and/or smeltered foundry manufacture process of combined highly pure metal, super alloy, and/or element. The pre pour technological standard includes nitrate, nitride, anodize, and benzotriazole, methyl, tolyltriazole, sodium chemical pre foundry treatment submersion bath flake and prill anticorrosive purification solution washing and screening table for the manufacture of copper and metals. Hot smelters prepare iron, manganese, lithium, cadmium, nickel, lead, copper, zinc, zirconium, aluminum, titanium, molybdenum, tungsten, or metal for die cast pours and are also utilized for layered foundry fills die cast pours of highly pure metal, super alloy, alkaline, alkalide, nonconductive zirconia, carbon nanofoam CNFs, alternate carbon nanofoam CNFs inductor, or impedance matching load or signal ceramic red brick clay insulator.

All mechanically refined metal ore may be sintered and/or smeltered element additive alloyed carbon nanofoam CNFs, tolyltriadole, sodium, benzotriadole, methyl, ammoniate, galvanize, anodize, nitrate, molybdenum, chromium, chromoloy, nitride, hydrochloric acid or combined alloyed sintered and/or smeltered highly pure metal, super alloy, alkaline, nonconductive zirconia, or impedance matching load or signal ceramic red brick clay insulator.

All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase design extrusions die casting for super alloy.

The super alloy is a layered greater than 0% to less than 100% highly pure metal or super alloy and greater than 0% to less than 100% highly pure metal or super alloy part that is created by pouring molten metal into a cast mold over a process of 2.5 phase design extrusions that create four molded casts for each designed master steel part that is manually machined and manufactured named part X the external layer highly pure metal or super alloy and part Z the internal layer highly pure metal or super alloy.

This replacement mold application is for the manufactured process of 2.5 phase design extrusions that creates a single part identical to the master designed and machined manufactured part. The new part chemical element becomes a super alloy that is layered greater than 0% to less than 100% highly pure metal, super alloy, alkaline, alkalide, nonconductive zirconia, carbon nanofoam CNFs, alternate carbon nanofoam CNFs inductor, or impedance matching load or signal ceramic red brick clay insulator and greater than 0% to less than 100% highly pure metal, super alloy, alkaline, alkalide, nonconductive zirconia, carbon nanofoam CNFs, alternate carbon nanofoam CNFs inductor, or impedance matching load or signal ceramic red brick clay insulator.

The manufacture process begins by a designed and machined manufactured master part named part X. The master part X is used to create two external cast halves. This is accomplished by casting the master part X into the center of two ceramic molded halves with newly poured ceramic slip and then may be placed in a damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit.

The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip and then may be placed in a damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by again pouring ceramic slip into the recesses and joining both halves with new cast covers to dry.

The external tolerances of all of the four cast covers X and Z are identical opposing so that X and Z halves can be joined and prepared for two separate halves molten highly pure metal or super alloy fills. After the poured molten highly pure metal or super alloy cools both extruded halves are removed and stored. The remainder halves with highly pure metal or super alloy fills are then joined and prepared for a second molten fill of greater than 0% to less than 100% highly pure metal or super alloy.

After the highly pure metal or super alloy is cooled the whole part is removed from the cast halves and is inspected, deburred, and finished.

The 14—Slurry electrolyte carbon reservoir brass or tool steel aperture conveys slurry electrolyte carbon Nanofoam CNFs to the 17—Tool steel extrusion die cast design internal cavity. Carbon nanofoam CNFs slurry electrolyte particle samples are taken and photospectometry analyzed measured in nanometers Nm to perfect electrolyte slurry formula.

The 16—Tool steel electronic servo or manual stop control release pull pin can be electronically disengaged or manually removed after the 10—Slurry electrolyte carbon tool steel reservoir is filled to begin the slurry electrolyte carbon extrusion.

The 18—Tool steel extrusion die cast design internal cavity regulator waste filter removes waste from the 17—Tool steel extrusion die cast design internal cavity while it is being filled with slurry electrolyte carbon. The 18—Tool steel extrusion die cast design internal cavity regulator waste filter and 18B—Tool steel vacuum release control with processing may utilize an external vacuum pump for required specifications specified scientific formula preform slurry electrolyte extrusion carbon nanofoam CNFs solids, liquids, and/or gases, heated, chilled, or room temperature chemical electrolyte ionic melts, ionic fluids, and/or fused, and/or catalyst acid and bases, actual catalyst, and/or catalyst reservoir with or without ionic suspension element specification 40 element, and/or specification 41 alloy.

The manufacture process of preform slurry electrolyte carbon nanofoam CNFs extrusion high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Utility patent application specification in the manufacture process of four sections 1. Preform slurry electrolyte carbon nanofoam CNFs extrusion high wear-heat resistant part, 2. Preform slurry electrolyte carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts, 3. Preform slurry electrolyte carbon nanofoam CNFs extrusion high wear-heat resistant parts aerospace, automotive, and transportation brake calipers, rotors, bushings, and pads, and 4. Preform slurry electrolyte carbon nanofoam CNFs extrusion high wear-heat resistant parts precision casting molds for the manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator specifically up to 2.5 phase extrusions and with up to six master preform slurry electrolyte carbon nanofoam CNFs extrusion high wear-heat resistant parts precision casting molds.

Utility patent application specification in the manufacture process of preform slurry electrolyte carbon nanofoam CNFs by the variable hydraulic preform slurry electrolyte carbon nanofoam CNFs extrusion high wear-heat resistant parts press FIG. 1 numbers 1 to 18. Number 5. The variable hydraulic preform slurry electrolyte carbon nanofoam CNFs extrusion high wear-heat resistant parts press with FIG. 1 numbers 1 to 18 specific parts that conform to specified requirements to unique American Society for Testing and Materials ASTM International Standards Worldwide Identifiers. The variable hydraulic preform slurry electrolyte carbon nanofoam CNFs extrusion high wear-heat resistant parts press, the center of this utility patent application specification slurry electrolyte formula in three scientific forms of Solids 6, Liquids 7 and Gases 8 noble gas argon or element in a gaseous state specified scientific formula preform slurry electrolyte extrusion carbon nanofoam CNFs solids, liquids, and/or gases, heated, chilled, or room temperature chemical electrolyte ionic melts, ionic fluids, and/or fused, and/or catalyst acid and bases, actual catalyst, and/or catalyst reservoir with or without ionic suspension element specification 40 element, and/or specification 41 alloy to manufacture preform slurry electrolyte carbon nanofoam CNFs extrusion high wear-heat resistant parts.

Utility patent application specification for with die cast mold extrusion or printing hot smelters casting and crucible casting usually two piece die cast set all manufacturing of specified highly pure metal, super alloy, alkaline, alkalide, nonconductive zirconia, carbon nanofoam CNFs, alternate carbon nanofoam CNFs inductor, or impedance matching load or signal ceramic red brick clay insulator including up to six master extrusion halves 2.5 phase extrusions per specification part molten foundry fill up to four pours and the manufacture process or assembly for each specification component or part thereof.

Utility patent application specification manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire drawing, annealing, and spun coils and windings for electronic component or other metal drawing and annealing process for wire and spun cable with or without woven textile synthetic resin or natural fibers unit of measurement in gage trade name Rebar Cable or Manufacture Process Connector System, cable connectors, powders, nitrate hardened or non hardened trade name Nitride Steel Grit unit of measurement in mesh or grit size and manufacturing of carbon nanofoam CNFs super alloy trade name Super Carbon Alloy. Carbon nanofoam CNFs sheets, plates, foil, leaf are electro-hydraulically pressed layered before drying into annealing spun and woven wire mesh and yield compound Super Carbon Alloy Mesh and high tensile strength carbon synthetic or natural fiber textiles.

Utility patent application specification 2.5 phase extrusions manufacturing of highly pure metal or super alloy specifically for precision casting of airframe, bearings, and assemblies, motor casings, aircraft landing gear, turbine blades, assemblies, and housings.

Utility patent application specification manufacturing of highly pure metal copper pre foundry mechanically refined copper ore anticorrosive treatment chemical submersion bath sodium, tolyltriazole, and methyl, benziotriole flake or prill washing and screening tables and chemical submersion bath techniques are utilized. In manufacturing of highly pure other metals mechanically refined ore iron, molybdenum, aluminum, zinc, zirconium, titanium, tungsten, or metal pre foundry anticorrosive treatment chemical submersion bath hydrochloric acid, ammonia from nitrogen, and hydrogen anticorrosive purification treatment.

Utility patent application specification manufacturing mechanically refined metal ore sintered and smeltered nonmetallic additive carbon nanofoam CNFs alloyed trade name Super Carbon Alloy, steel trade name Super Carbon Steel, tungsten trade name Super Carbon Tungsten, or additive sintered and smeltered molybdenum for homogenization steel trade name Molybdenum Steel, or tungsten trade name Molybdenum Tungsten.

Utility patent application specification manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator 2.5 phase extrusions or half-shell extruded composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts highly pure metal, super alloy, alkaline, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, super alloy, alkaline, alkalide, nonconductive zirconia, impedance matching load or signal ceramic red brick clay insulator, carbon nanofoam CNFs, or alternate carbon nanofoam CNFs inductor, or up to three sides zircon cutting tools, or two sides continuous for drill bits half-shell extruded tools measured in gage.

Utility patent application specification manufacturing of highly pure metal or super alloy tool steel tungsten forge die cast tool, crimping tool for trade name Rebar Cable or Manufacture Process Connector System, specific tool steel parts that conform to specified requirements to unique American Society for Testing and Materials ASTM International Standards Worldwide Identifiers the variable hydraulic preform slurry electrolyte carbon nanofoam CNFs extrusion high wear-heat resistant parts press FIG. 1 numbers 1 to 18 and tool steel tungsten die cast extrusion molds for with manufacturing highly pure metal, super alloy, alkaline, alkalide, nonconductive zirconia, impedance matching load or signal ceramic red brick clay insulator, carbon nanofoam CNFs, or alternate carbon nanofoam CNFs inductor.

Utility patent application specification manufacture process of replacement ceramic precision casting molds specification number 23 for with manufacturing highly pure metal, super alloy, alkaline, alkalide, nonconductive zirconia, impedance matching load or signal ceramic red brick clay insulator, carbon nanofoam CNFs, or alternate carbon nanofoam CNFs inductor.

Utility patent application specification manufacture process of preform slurry electrolyte carbon nanofoam CNFs with or without ionic suspension element specification 40 element or specification 41 alloy extrusion or casted highly pure metal, super alloy, carbon nanofoam CNFs with or without ionic suspension element specification 40 element or specification 41 alloy, and alkaline, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink all architecture in series or parallel circuit two positive and negative +/− terminals measured in Volts symbol V, or of preform slurry electrolyte alternate carbon nanofoam CNFs inductor extrusion, or casted highly pure metal, super alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground architecture in series or parallel circuit two negative −/− terminals measure in Ohms symbol Ω of inductor, antinode coupler, and ground or two positive and negative +/− terminals measured in Volts symbol V. All electronic parts two sides casted conductive plate, sheet, foil, or leaf highly pure metal, super alloy, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, super alloy, and/or alkaline, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, super alloy, and/or alkaline, or alkalide, plate, sheet, foil, or leaf casted architecture in series or parallel circuit and two positive and negative +/− terminals measured in Volts symbol V, or two negative −/− terminals measured in Ohms symbol Ω to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, super alloy, and/or alkaline, or alkalide, plate, sheet, foil, or leaf casted architecture in series or parallel circuit, and two positive and negative +/− terminals measured in Volts symbol V, or two negative −/− terminals measured in Ohms symbol Ω to antinode coupler preform slurry electrolyte casted ionic suspension element carbon nanofoam CNFs battery cell outstanding one or two sides plate, sheet, foil, or leaf casted conductive highly pure metal, super alloy, or alkalide architecture in series or parallel circuit, and two positive and negative +/− terminals measured in Volts symbol V, or two negative −/− terminals measured in Ohms symbol Ω to antinode coupler, or electronic parts requires one, or two, or more brushes in even intervals and two or more inductors and antinode couplers with one or two sides conductive plate, sheet, foil, or leaf casted highly pure metal, super alloy, or alkalide architecture in series or parallel circuit, and two positive and negative +/− terminals measured in Volts symbol V, or two negative −/− terminals measured in Ohms symbol Ω to antinode coupler.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B—Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—TI—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—Rg—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire; Al—Li aluminum, lithium, sometimes mercury; Alnico aluminum, nickel, copper; Duralumin copper, aluminum; Magnalium aluminum, 5% magnesium; Magnox magnesium oxide, aluminum; Nambe aluminum plus seven other unspecified metals; Silumin aluminum, silicon; and Zamak zinc, aluminum, magnesium, copper; Aluminum forms other complex alloys with magnesium, manganese, and platinum. Bismuth Alloys Wood's metal bismuth, lead, tin, cadmium; Rose metal bismuth, lead, tin; Field's metal; and Cerrobend. Cobalt Alloys Megallium; and Stellite cobalt, chromium, tungsten or molybdenum, carbon Talonite cobalt, chromium. Ultimet cobalt, chromium, nickel, molybdenum, iron, tungsten; and Vitallium. Copper Alloys Arsenical copper; Beryllium copper, beryllium; and Billon copper, silver. Brass copper, zinc; Calamine brass copper, zinc; Chinese silver copper, zinc; Dutch metal copper, zinc; Gilding metal copper, zinc; Muntz metal copper, zinc; Pinchbeck copper, zinc; Prince's metal copper, zinc; and Tombac copper, zinc. Bronze copper, tin, aluminum or other element; Aluminum bronze copper, aluminum; Arsenical bronze copper, arsenic; Bell metal copper, tin; Florentine bronze copper, aluminum or tin; Glucydur beryllium, copper, iron; Guanin likely a manganese bronze of copper, manganese, with iron sulfides and other sulfides; Gunmetal copper, tin, zinc; Phosphor bronze copper, tin and phosphorus; Ormolu Gilt Bronze copper, zinc; and Speculum metal copper, tin. Constantan copper, nickel; Copper-tungsten copper, tungsten; Corinthian bronze copper, gold, silver; Cunife copper, nickel, iron; Cupronickel copper, nickel; Cymbal alloys Bell metal copper, tin; Devarda's alloy copper, aluminum, zinc; Electrum copper, gold, silver; Hepatizon copper, gold, silver; Heusler alloy copper, manganese, tin; Manganin copper, manganese, nickel; Nickel silver copper, nickel; Nordic gold copper, aluminum, zinc, tin; Shakudo copper, gold; and Tumbaga copper, gold. Gallium Alloys Galinstan gallium, indium, tin. Gold Alloys Electrum gold, silver, copper; Tumbaga gold, copper; Rose gold, copper; and White gold, nickel, palladium, or platinum. Indium Alloys Field's metal indium, bismuth, tin. Iron or Ferrous Alloys Steel carbon Stainless steel chromium, nickel; AL-6XN; Alloy 20; Celestrium; Marine grade stainless; Martensitic stainless steel; and Surgical stainless steel chromium, molybdenum, nickel. Silicon steel silicon; Tool steel tungsten or manganese; Bulat steel; Chromoly chromium, molybdenum; Crucible steel; Damascus steel; HSLA steel; High speed steel; Maraging steel; Reynolds 531; and Wootz steel. Iron Anthracite iron carbon; Cast iron carbon; Pig iron carbon; and Wrought iron carbon. Fernico nickel, cobalt; Elinvar nickel, chromium; Invar nickel; Kovar cobalt; and Spiegeleisen manganese, carbon, silicon. Ferroalloys Ferroboron; Ferrochrome chromium; Ferromagnesium; Ferromanganese; Ferromolybdenum; Ferronickel; Ferrophosphorus; Ferrotitanium; Ferrovanadium; and Ferrosilicon. Lead Alloys Antimonial lead, antimony; Molybdochalkos lead, copper; Solder lead, tin; Terne lead, tin; and Type metal lead, tin, antimony. Magnesium Alloys Magnox magnesium, aluminum T—Mg—Al—Zn Bergman phase; and Elektron. Mercury Alloys Amalgam mercury and other metal except platinum. Nickel Alloys Alumel nickel, manganese, aluminum, silicon; Chromel nickel, chromium; Cupronickel nickel, bronze, copper; German silver nickel, copper, zinc; Hastelloy nickel, molybdenum, chromium, sometimes tungsten; Inconel nickel, chromium, iron; Monel metal copper, nickel, iron, manganese; Mu-metal nickel, iron; Ni—C nickel, carbon; Nichrome chromium, iron, nickel; Nicrosil nickel, chromium, silicon, magnesium; Nisil nickel, silicon; and Nitinol nickel, titanium, shape memory alloy. Potassium Alloys KLi potassium, lithium; and NaK sodium, potassium. Rare Earth Alloys Mischmetal various rare earths. Silver Alloys Argentium sterling silver, copper, germanium; Billon copper or copper bronze, sometimes with silver; Britannia silver, copper; Electrum silver, gold; Goloid silver, copper, gold; Platinum sterling silver, platinum; Shibuichi silver, copper; and Sterling silver, copper. Tin Alloys Britannium tin, copper, antimony; Pewter tin, lead, copper; and Solder tin, lead, antimony. Titanium Alloys Beta C titanium, vanadium, chromium, other metals; and 6al-4v titanium, aluminum, vanadium. Uranium Alloys Staballoy depleted uranium with titanium or molybdenum; and Uranium may also be alloyed with plutonium. Zinc Alloys Brass zinc, copper; and Zamak zinc, aluminum, magnesium, copper. Zirconium Alloys Zircaloy zirconium and tin, sometimes with niobium, chromium, iron, nickel.

1. Utility patent application specification in the manufacture process of four sections 1. Preform slurry electrolyte carbon nanofoam CNFs extrusion high wear-heat resistant part, 2. Preform slurry electrolyte carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts, 3. Preform slurry electrolyte carbon nanofoam CNFs extrusion high wear-heat resistant parts aerospace, automotive, and transportation brake calipers, rotors, bushings, and pads, and 4. Preform slurry electrolyte carbon nanofoam CNFs extrusion high wear-heat resistant parts precision casting molds for the manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator specifically up to 2.5 phase extrusions and with up to six master preform slurry electrolyte carbon nanofoam CNFs extrusion high wear-heat resistant parts precision casting molds.

2. Utility patent application specification in the manufacture process of preform slurry electrolyte carbon nanofoam CNFs by the variable hydraulic preform slurry electrolyte carbon nanofoam CNFs extrusion high wear-heat resistant parts press FIG. 1 numbers 1 to 18. Number 5. the variable hydraulic preform slurry electrolyte carbon nanofoam CNFs extrusion high wear-heat resistant parts Press with FIG. 1 numbers 1 to 18 specific parts that conform to specified requirements to unique American Society for Testing and Materials ASTM International Standards Worldwide Identifiers. The variable hydraulic preform slurry electrolyte carbon nanofoam CNFs extrusion high wear-heat resistant parts press, the center of this utility patent application specification slurry electrolyte formula in three scientific forms of 6 Solids, 7 Liquids and 8 Gases noble gas argon or element in a gaseous state specified scientific formula preform slurry electrolyte extrusion carbon nanofoam CNFs solids, liquids, and/or gases, heated, chilled, or room temperature chemical electrolyte ionic melts, ionic fluids, and/or fused, and/or catalyst acid and bases, actual catalyst, and/or catalyst reservoir with or without ionic suspension element specification 40 element, and/or specification 41 alloy to manufacture preform slurry electrolyte carbon nanofoam CNFs extrusion high wear-heat resistant parts. 9. Slurry electrolyte carbon tool steel line in can be ionic process tool steel interface positive or negative electrode electronically charged CNFs and electrolyte particle for enhanced formulation. 10. Specified amount of slurry electrolyte carbon is compressed to preform slurry electrolyte carbon nanofoam CNFs extrusion specification pressure measured in millibars Mb. 11. Slurry electrolyte carbon reservoir regulated tool steel waste filter removes waste from the Slurry electrolyte carbon tool steel reservoir while it is being filled with slurry electrolyte carbon from common recovery distillation heated interface tool steel and thermometer gauge, ordinary atmospheric pressure, vacuum pump barometric pressure measured in millibars Mb, and fractional distillation. 12. Tool steel extrusion die cast design internal cavity regulator waste filter and tool steel vacuum release control and portal works in unison with the ASTM press plate drawing expanding and contracting slurry electrolyte carbon removing waste from the tool steel extrusion die cast design internal cavity while it is being filled with slurry electrolyte carbon from common recovery distillation heated interface tool steel and thermometer gauge, ordinary atmospheric pressure, vacuum pump barometric pressure measured in millibars Mb, and fractional distillation.

3. Utility patent application specification for with die cast mold extrusion or printing hot smelters casting manufacturing of specified highly pure metal, super alloy, alkaline, alkalide, nonconductive zirconia, carbon nanofoam CNFs, alternate carbon nanofoam CNFs inductor, or impedance matching load or signal ceramic red brick clay insulator, including up to six master extrusion halves 2.5 phase extrusions per specification part, molten foundry fill up to four pours, and the manufacture process or assembly for each specification component or part thereof. 13. Utility patent application specification manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component, or other metal drawing and annealing process for Wire, and spun Cable, with or without woven textile synthetic resin or natural fibers unit of measurement in gage trade name Rebar Cable or Manufacture Process Connector System, cable connectors, powders, nitrate hardened or non hardened trade name Nitride Steel Grit unit of measurement in mesh or grit size and manufacturing of carbon nanofoam CNFs super alloy trade name Super Carbon Alloy. Carbon nanofoam CNFs sheets, plates, foil, leaf are electro-hydraulically pressed layered before drying into annealing spun and woven wire mesh and yield compound Super Carbon Alloy Mesh and high tensile strength carbon synthetic or natural fiber textiles. 14. Utility patent application specification 2.5 phase extrusions manufacturing of highly pure metal or super alloy specifically for precision casting of airframe, bearings, and assemblies, motor casings, aircraft landing gear, turbine blades, assemblies, and housings. 15. Utility patent application specification manufacturing of highly pure metal copper pre foundry mechanically refined copper ore anticorrosive treatment chemical submersion bath sodium, tolyltriazole, and methyl, benziotriole flake or prill washing and screening tables and chemical submersion bath techniques are utilized. In manufacturing of highly pure other metals mechanically refined ore iron, molybdenum, aluminum, zinc, zirconium, titanium, tungsten, or metal pre foundry anticorrosive treatment chemical submersion bath hydrochloric acid, ammonia from nitrogen, and hydrogen anticorrosive purification treatment. 16. Utility patent application specification manufacturing mechanically refined metal ore sintered and smeltered nonmetallic additive carbon nanofoam CNFs alloyed trade name Super Carbon Alloy, steel trade name Super Carbon Steel, tungsten trade name Super Carbon Tungsten, or additive sintered and smeltered molybdenum for homogenization steel trade name Molybdenum Steel, or tungsten trade name Molybdenum Tungsten. 17. Utility patent application specification manufacturing of highly pure metal, super alloy, alkaline, alkalide, nonconductive zirconia, carbon nanofoam CNFs, alternate carbon nanofoam CNFs inductor, or impedance matching load or signal ceramic red brick clay insulator 2.5 phase extrusions or half-shell extruded composite coils, composite windings, brushes, inductors, antinode couplers, electric rheostats, starters, motors, alternators, generators, ionic suspension element enhanced composite coils, composite windings, brushes, capacitors, battery cells, rheostats, or electronic parts, electronic resistors, or electronic parts, transformers, transducers, rectifiers, power supplies, heat sinks, or electronic parts highly pure metal, super alloy, alkaline, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, super alloy, alkaline, alkalide, nonconductive zirconia, impedance matching load or signal ceramic red brick clay insulator, carbon nanofoam CNFs, or alternate carbon nanofoam CNFs inductor, or up to three sides zircon cutting tools, or two sides continuous for drill bits half-shell extruded tools measured in gage. 18. Utility patent application specification manufacturing of highly pure metal or super alloy tool steel tungsten forge die cast tool, crimping tool for trade name Rebar Cable or Manufacture Process Connector System, specific tool steel parts that conform to specified requirements to unique American Society for Testing and Materials ASTM International Standards Worldwide Identifiers The variable hydraulic preform slurry electrolyte carbon nanofoam CNFs extrusion high wear-heat resistant parts Press FIG. 1 numbers 1 to 18 and tool steel tungsten die cast extrusion molds for with manufacturing highly pure metal, super alloy, alkaline, alkalide, nonconductive zirconia, impedance matching load or signal ceramic red brick clay insulator, carbon nanofoam CNFs, or alternate carbon nanofoam CNFs inductor. 19. Utility patent application specification manufacture process of replacement ceramic precision casting molds specification number 23 for with manufacturing highly pure metal, super alloy, alkaline, alkalide, nonconductive zirconia, impedance matching load or signal ceramic red brick clay insulator, carbon nanofoam CNFs, or alternate carbon nanofoam CNFs inductor. 20. Utility patent application specification manufacture process of preform slurry electrolyte carbon nanofoam CNFs with or without ionic suspension element specification 40 element or specification 41 alloy extrusion or casted highly pure metal, super alloy, carbon nanofoam CNFs with or without ionic suspension element specification 40 element or specification 41 alloy, and alkaline, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink all architecture in series or parallel circuit two positive and negative +/− terminals measured in Volts symbol V, or of preform slurry electrolyte alternate carbon nanofoam CNFs inductor extrusion, or casted highly pure metal, super alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground architecture in series or parallel circuit two negative −/− terminals measure in Ohms symbol Ω of inductor, antinode coupler, and ground or two positive and negative +/− terminals measured in Volts symbol V. All electronic parts two sides casted conductive plate, sheet, foil, or leaf highly pure metal, super alloy, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, super alloy, and/or alkaline, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, super alloy, and/or alkaline, or alkalide, plate, sheet, foil, or leaf casted architecture in series or parallel circuit and two positive and negative +/− terminals measured in Volts symbol V, or two negative −/− terminals measured in Ohms symbol Ω to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, super alloy, and/or alkaline, or alkalide, plate, sheet, foil, or leaf casted architecture in series or parallel circuit, and two positive and negative +/− terminals measured in Volts symbol V, or two negative −/− terminals measured in Ohms symbol Ω to antinode coupler preform slurry electrolyte casted ionic suspension element carbon nanofoam CNFs battery cell outstanding one or two sides plate, sheet, foil, or leaf casted conductive highly pure metal, super alloy, or alkalide architecture in series or parallel circuit, and two positive and negative +/− terminals measured in Volts symbol V, or two negative −/− terminals measured in Ohms symbol Ω to antinode coupler, or electronic parts requires one, or two, or more brushes in even intervals and two or more inductors and antinode couplers with one or two sides conductive plate, sheet, foil, or leaf casted highly pure metal, super alloy, or alkalide architecture in series or parallel circuit, and two positive and negative +/− terminals measured in Volts symbol V, or two negative −/− terminals measured in Ohms symbol Ω to antinode coupler.
